(19) United States
(12) Patent Application Publication
(10) Pub. No.: US 2023/0380046 A1
(43) Pub. Date: Nov. 23, 2023

(54) ION SOURCE FOR NEUTRON GENERATOR USABLE IN WELLBORE

(71) Applicant: Halliburton Energy Services, Inc., Houston, TX (US)

(72) Inventors: Zilu Zhou, Needham, MA (US); Weijun Guo, Houston, TX (US)

(21) Appl. No.: 18/148,883

(22) Filed: Dec. 30, 2022

Related U.S. Application Data
(60) Provisional application No. 63/342,748, filed on May 17, 2022.

(51) Int. Cl. H05H 3/06; H01J 27/20

(52) U.S. Cl. CPC H05H 3/06; H01J 27/205

(57) ABSTRACT

A neutron generator with an ion source within a housing may be used for generating neutrons for neutron logging downhole in a wellbore. The ion source within the housing of the neutron generator may include a hot cathode, an ion source cylinder, a first grid separated from the ion source cylinder, and an extractor separated from the ion source cylinder, the extractor having a second grid.

### CROSS-REFERENCE TO RELATED APPLICATION

This claims priority to U.S. Provisional Patent Application No. 63/342,748, filed May 17, 2022 and titled “Ion Source for Neutron Generator Usable in Wellbore,” the entirety of which is incorporated herein by reference.

### TECHNICAL FIELD

The present disclosure relates generally to wellbore operations and, more particularly (although not necessarily exclusively), to an ion source for a neutron generator for use in a wellbore.

### BACKGROUND

Wells can be drilled to access and produce hydrocarbons such as oil and gas from subterranean geological formations. Wellbore operations can include drilling operations, completion operations, fracturing operations, and production operations. Drilling operations may involve gathering information related to downhole geological formations of the wellbore. The information may be collected by wireline logging, logging while drilling (LWD), measurement while drilling (MWD), drill pipe conveyed logging, or coil tubing conveyed logging. Collecting information can be challenging.

### BRIEF DESCRIPTION OF THE DRAWINGS

FIG. 1 is a schematic of a wellbore system with a logging tool having an ion source for a neutron generator according to one example of the present disclosure.

FIG. 2 is a schematic of an ion source within a housing of a neutron generator that includes a grid separated from an ion source cylinder according to one example of the present disclosure.

FIG. 3 is a schematic of a neutron generator that includes an ion source and a target according one example of the present disclosure.

FIG. 4 is a schematic of a neutron generator with a concave-shaped grid on an extractor according to one example of the present disclosure.

FIG. 5 is a schematic of a neutron generator with a flat-shaped grid on an extractor according to one example of the present disclosure.

FIG. 6 is a schematic of a neutron generator with a convex-shaped grid on an extractor according to one example of the present disclosure.

FIG. 7 is a schematic of a neutron generator with a convex-shaped grid for generating ions directed at a target according to one example of the present disclosure.

FIG. 8 is a graph of electron emission current as a function of grid voltage for a hot cathode of a neutron generator according to one example of the present disclosure.

FIG. 9 is a flowchart of a process for using a neutron generator for generating neutrons downhole in a wellbore according to one example of the present disclosure.

### DETAILED DESCRIPTION

Certain aspects and features of the present disclosure relate to a hot cathode-based ion source with the triode structure that includes a separated first grid, an ion source cylinder, and an extractor that is with a concave-shaped, or a flat-shaped or a convex-shaped second grid. The ion source can be used in a wellbore to generate neutrons. The separated first grid can be freely applied by a higher voltage to achieve a higher electron emission from the hot cathode with optimization. And, the ion source cylinder can be applied by a lower voltage to de-accelerate the electron beam to the energy region with higher ionization cross sections. Combined with an extractor that has a concave-shaped, a flat-shaped, or a convex-shaped second grid and a negative voltage, three electrodes can work together to re-circulate electrons inside the ion source volume for multiple round trips. This can result in more ionizations or higher efficiency in ionization. Furthermore, the three electrodes can act together for a push-pull effect with a close to dipole electrical field inside the entire ion source volume to provide an efficient ion extraction. And reversely, the three electrodes can work as a tandem for turning on and off an ion beam for a fast-pulsing operation. The extractor with a concave-shaped, flat-shaped, or convex-shaped second grid can be used to control the ion beam optics in the acceleration column in advance, which can impact the acceleration distance to target and the ion beam spot size on target.

An ion source according to some examples can be easily controlled in operation, with a set of separated control parameters. The ion source can be more efficient for providing an ion beam. This can lead to a lower power consumption, a lower gas pressure inside the neutron tube during operation, and a better performance. The ion source can have a better ion beam optics, a shorter distance of acceleration column to target, and a bigger beam spot size on target. This can result in a longer lifetime.

A compact deuterium (D) and tritium (T) neutron generator can be used in a downhole nuclear logging tool for oil or gas well measurements, in an environment of elevated temperatures. The neutron generator can include a sealed tube as vacuum housing, a gas reservoir for storing D/T gas, an ion source for generating ions that are accelerated by a high voltage system, and a target for facilitating the DT fusion reactions to generate neutrons.

A neutron-generating tube may be based on the so-called “penning ion source technology,” where the D/T ions are produced by spontaneous discharges inside the source volume, then extracted and accelerated to bombard a target (also containing D/T molecules). This type of tube may have low neutron yields, short lifetimes of approximately 500 hours, and slow pulse rise/fall times in pulsed operations. These attributes can lead to operating at high gas pressures (˜10-20 mTorr) inside the tube.

By introducing a dispenser (e.g., hot cathode) to emit electrons, the gas molecules can be ionized directly to produce an ion beam with the same or higher beam current at lower gas pressures (e.g., in a few mTorr) with less beam-gas collisions. This can result in a longer lifetime (e.g., approximately 1000 hours) at higher neutron yields (e.g., approximately 3×10⁸ n/sec) when maintaining a 100 μA ion beam bombarding a 100 kV target. In addition, the ion beam can be quickly switched on or off by controlling the electron mission from the hot cathode to stop ionization and the ion beam extraction inside the ion source. This can allow for fast and sharp pulsing in a 100-500 nsec region.

In some examples, a hot cathode ion source that is part of a compact neutron-generating tube for down hole applications can be in an open structure with multiple washers used as electrodes and ceramic housing rings as spacers in a brazened stack. The ion source can include a hot cathode, an ion source cylinder with a first grid facing the hot cathode for controlling electron emission, and an extractor which has a concave shaped second grid for ion extraction. Voltages can be applied to the hot cathode (V_{HC}), ion source cylinder with a first grid (V_{G}), and extractor with a second grid (V_{E}). The ion source is a diode structure dictated by V_{G}.

In some examples, a hot cathode-based ion source is included as part of a compact neutron generator and maintained in an open structure with multiple washers used as electrodes and ceramic housing rings as spacers in a brazened stack. The first grid can be separated from the ion source cylinder, and the extractor can have a concave-shaped, a flat-shaped, or a convex-shaped second grid. Voltages can be applied to the hot cathode (V_{HC}), separated first grid (V_{G}), ion source cylinder (V_{IC}), and extractor with a second grid (V_{E}). A set of notations r, d, and Lᵢ can, respectively, correlate to a radius of a hot cathode surface, the distance between the surface of hot cathode to the first grid, and the length of ion source volume. “Iₑ” and “Iᵢ” can represent the electron emission and extracted ion currents.

By separating the first grid from the ion source cylinder, the diode structure dictated by V_{G} only, now changes to a triode ion source structure, which is controlled by two separated parameters V_{G} and V_{IC} applied on the first grid and ion source cylinder separately, while the third parameter V_{E} is maintained on the extractor with a second grid.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

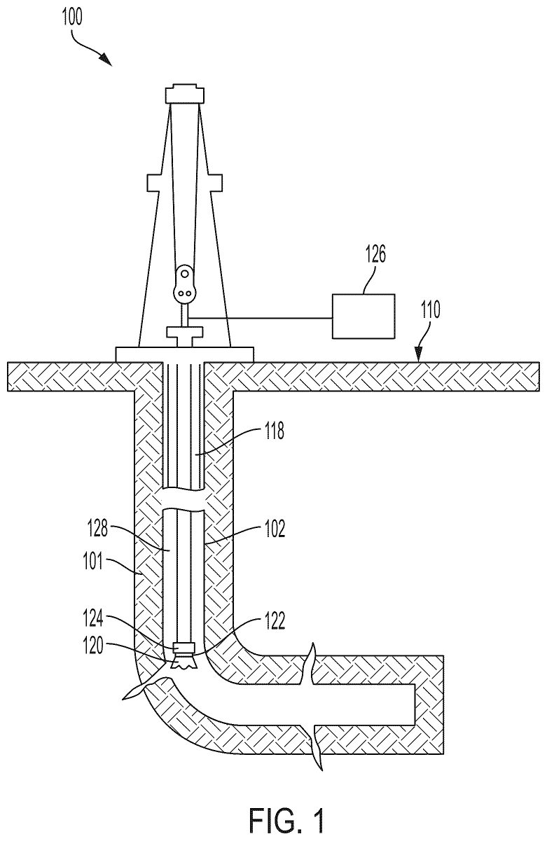

FIG. 1 is a schematic of a wellbore system 100 with a logging tool having an ion source for a neutron generator according to one example of the present disclosure. In this example, the wellbore system 100 is depicted for a well, such as an oil or gas well, for extracting fluids from a subterranean formation 101. The wellbore system 100 may be used to create a wellbore 102 from a surface 110 of the subterranean formation 101. The wellbore system 100 includes a well tool or downhole tool 118, and a drill bit 120. The downhole tool 118 can be any tool used to gather information about the wellbore 102. For example, the downhole tool 118 can be a tool delivered downhole by wireline, often referred to as wireline formation testing (“WFT”). Alternatively, the downhole tool 118 can be a tool for either measuring-while-drilling, wireline logging, or logging-while-drilling. The downhole tool 118 can include a neutron generator and a sensor component 122 for determining information about the wellbore 102. Examples of information can include rate of penetration, weight on bit, standpipe pressure, depth, mud flow in, rotations per minute, torque, equivalent circulation density, or other parameters. The downhole tool 118 can also include a transmitter 124 for transmitting data from the sensor component 122 to the surface 110. The downhole tool 118 can further include the drill bit 120 for drilling the wellbore 102.

The wellbore 102 is shown as being drilled from the surface 110 and through the subterranean formation 101. As the wellbore 102 is drilled, drilling fluid can be pumped through the drill bit 120 and into the wellbore 102 to enhance drilling operations. As the drilling fluid enters the wellbore, the drilling fluid circulates back toward the surface 110 through a wellbore annulus 128.

Also included in the schematic diagram is a computing device 126. The computing device 126 can be communicatively coupled to the downhole tool 118 and receive data about the drilling or logging process. Upon receiving the data, the computing device 126 can process and display the data to a user.

A compact deuterium (D) and tritium (T) neutron generator can be used in a downhole nuclear logging tool for oil or gas well measurements. The neutron generator can include a sealed tube as vacuum housing, a gas reservoir for storing D-T gas, an ion source for generating ions that are accelerated by a high voltage system, and a target for facilitating the D-T fusion reactions to generate neutrons.

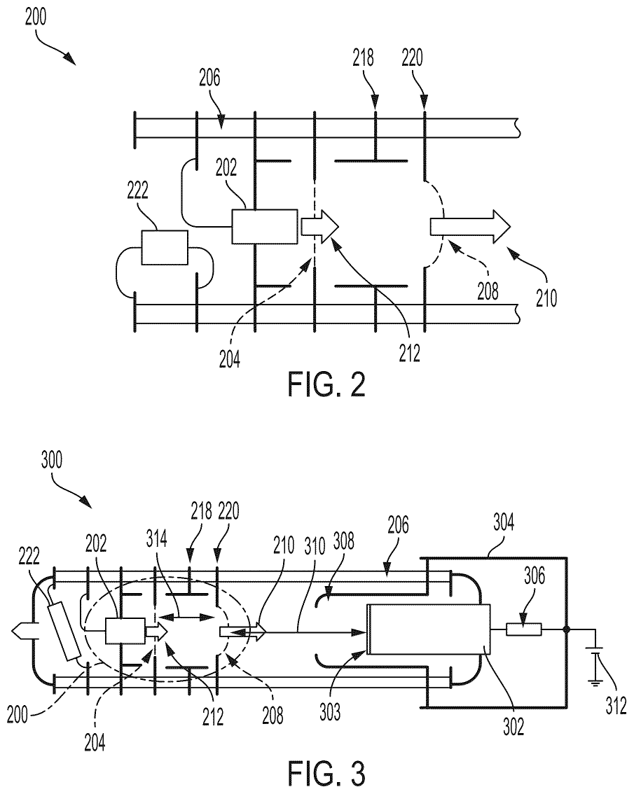

FIG. 2 is a schematic of an ion source 200 within a housing 206 of a neutron generator that includes a first grid 204 separated from an ion source cylinder 218 according to one example of the present disclosure. The ion source 200 of FIG. 2 can include a housing 206 as part of a sealed tube, a gas reservoir 222 for providing gas, and a hot cathode 202 for providing an electron beam 212 directed to the region of ion source cylinder 218 for generating ions. The ion source 200 of FIG. 2 further depicts an ion beam 210 that can be extracted and subsequently accelerated by a high voltage system or other means to a certain energy, directed at a target for facilitating D-D, T-T, or D-T fusion reactions to generate neutrons. An extractor 220 with a second grid 208 can be configured to extract the ion beam 210 from the ion source for being accelerated to the target. The second grid 208 can be a convex-shaped, concave-shaped, or flat-shaped grid. Because D₂ or T₂ or a mixture of D₂ and T₂ is in a gas form, the gas reservoir 222 is configured to store and provide the gas for the ion source. A target can be a metal where the same gas is absorbed. The target, made of metal, can be a thin film deposited on a backing structure, block, or rod, which can be used for mechanical support and electrical connection. In addition, the backing structure can also be used for transferring heat generated by the ion bombardment at the thin film to outside the housing for dissipation.

FIG. 3 is a schematic of a neutron generator 300 that includes an ion source 200 and a target according one example of the present disclosure. The neutron generator 300 can also be referred to as a neutron-generating tube. The first grid 204 of the ion source can be physically separated from the ion source cylinder. The second grid 208 on the extractor 220 can also be separated from the ion source cylinder and can have a flat-shaped, a concave-shaped, or a convex-shaped grid. Controlling voltages can be applied to the hot cathode 202, the first grid 204, the ion source cylinder 218, and the extractor 220 to form a triode structure.

FIG. 3 further shows an integrated neutron generator 300 with the ion source 200 as shown in FIG. 2. Additionally, a distance 310 is the distance from the extractor 220 to a target film 303 in the acceleration volume. The neutron generator 300 includes the ion source 200, a suppressor 308, the target film 303, and a target rod 302 as a backing structure. High voltages can be applied to the suppressor 308 (V_{S}) and target rod 302 (V_{T}) for accelerating the ion beam to bombard the target film 303.

The neutron generator 300 can be filled with a mixture of D₂ and T₂ gas, in a 50-50% ratio, stored in the gas reservoir 222. The same D₂ and T₂ gas mixture can be loaded in the target film 303, typically a film made of titanium that can be facing the ion source 200. The target film 303 can be coated on a target rod 302 made of copper as the backing structure. The target rod 302 can act as an electrical connector to an HV power supply and a thermal conductor to transfer any excessive heat from the target to outside. In this way, D₂ and T₂ atomic and molecular ions, generated from the ion source 200, are accelerated to bombard the target film 303 loaded with the same gas. And then, the D-T, or T-D fusion reactions occur at a given high voltage to generate neutrons. The D-D fusion reaction can have low cross-sections in the same HV region. The neutron generator 300 may additionally include a resistor 306 (e.g., 2 MΩ) between the target rod 302 and a high voltage source 312. The high voltage source 312 can also be coupled to a corona shield 304 that can connect to the suppressor 308, which may be an electrode. The corona shield 304 can be coupled outside of the housing 206 and provide a connection to the suppressor 308 and smoothening of an electrical field outside the housing 206 in the region of the target rod 302. The suppressor 308 can be engineered with a bias E-field to send back or suppress any low-energy, secondary emission electrons. The suppressor 308 can also serve as a trap for ions that may reflect away, in a scattered manner, from the target rod 302 upon impact. Such reflected ions can be referred to as backscattered ions. The suppressor 308 may encapsulate at least a portion of the target rod 302 to suppress backscattered ions and secondary emission electrons within the housing 206 of the neutron generator 300.

Hot cathode emission is governed by the Child Law (or the Child-Langmuir Law or three-halves-power law). It gives the maximum space-charge-limited current in a planar diode structure as a function of the distance and potential difference between the hot cathode 202 and the first grid 204, provided that the hot cathode 202 has sufficient heating so that plenty electron charges hover near its surface space. By applying a given potential difference, the electron beam 212 is extracted and shot, passing through the first grid 204, assuming the grid has a close to 100% transparency. That is:

$${I}_{e} = K \frac{{V}_{g}^{3 / 2}}{{d}^{2}} A = K \frac{{V}_{g}^{3 / 2}}{{d}^{2}} π {r}^{2} \qquad ( 1 )$$

In equation (1), Iₑ is the electron current (mA), V_{g} the voltage difference between cathode and grid (V), d the distance between cathode and grid (mm), A the surface area of cathode with a radius of r (mm²). For electrons, k=0.002334 mA V^{-3/2}.

FIGS. 2 and 3 show schematics in a tube-like geometry, where the hot cathode 202 is mounted, positioned next to the first grid 204 structure, as introduced previously. Here, the radius of the hot cathode 202 surface is r, the distance from the hot cathode 202 to the first grid 204 is d, and the bias voltage on the first grid 204 is V_{G} after ignoring the small value of the hot cathode. By choosing a geometry which is practical in a tube-like structure, for example, r=2 mm, d=1.5 mm, using Eq. 1, the electron current can be plotted as a function of the bias voltage applied on the grid.

The hot cathode 202 can send an electron beam 212 to ionize hydrogen or hydrogen isotope (D/T) gas at a given pressure in the region of the ion source cylinder 218. Then, the ionized gas can be extracted in the form of an ion beam 210. For hydrogen and hydrogen isotope molecular ionization, cross sections can be functions of electron impact energy in a range from 0 eV to a few keV. An electron energy range of interest can be from 80 eV to 200 eV, while the cross sections can be in the range of 0.7 and 1.0 A² (an average of 0.85 A²), equivalent to about one Bohr radius in size. With a separated, first grid 204, this can be optimized in the ion source 200 by adjusting the voltage of the ion source cylinder 218 lower than the voltage of the first grid 204, close to 100-150 V.

Subsequently, assuming a close to 100% ion extraction efficiency, the ion beam 210 current extracted can be expressed in the following equation:

I_{I}=Iₑn_{DT}L_{I}σ (2)

In equation (2), I_{I} is the ion current of the ion beam 210, Iₑ is the electron current of the electron beam 212 from the hot cathode (e.g., 50 mA) 202, L_{I} is a length 314 between the first grid 204, and the extractor 220 in the region of the ion source cylinder 218 (e.g., 1.0 cm), and σ is the hydrogen molecular ionization cross section at a given electron energy (e.g., between 80-100 eV). n_{DT} is the D-T molecular gas pressure in the region of the ion source cylinder 218 at a given heating power on the gas reservoir 222 (e.g., 1.0 mTorr), which can be converted to molecules/cm³ assuming a standard temperature condition.

That is, given the above operating parameters, mainly 1.0 mTorr and 50 mA in a 1.0 cm geometry, 150 μA ion current can pass therethrough, assuming a 100% efficiency for ion extraction. Both transparencies of the first grid 204 and the second grid 208 on the extractor 220 can reduce the final ion beam 210 current. But, the gas pressure can be a parameter that can be adjusted higher to compensate any ion losses.

In some examples, the gas reservoir 222 is heated to generate 1.0 mTorr or higher gas pressure. The hot cathode 202 is heated sufficiently so that plenty electron charges hover near its surface space. By applying a voltage on the first grid 204 in a range of 200-250 V, one can have an electron beam 212 with a current of 40-50 mA shooting into the region of the ion source cylinder 218. With 100-150 V in the ion source cylinder 218, the electrons will be deaccelerated for ionization with the highest cross-section to produce more ions. Then sufficient ions can be extracted with the extractor 220 when a voltage is applied between 0 to −50 V.

Relatively low control voltages (<300 v) can be used for the ion source with a triode structure. The electrons can be accelerated and deaccelerated before and after passing the first grid 204 to give best results. Separated controls can be used for electrons and ions.

The ion source 200, according to some examples, can be based on electron-impact direct ionization. A plasma formation in the region of the ion source cylinder 218 may not be needed. Thus, the ion beam 210 pulsing can be made very fast, with the pulsing rise and fall times being in a range of 100-500 nsec. And, the ion source 200 structure can have a small capacitance and impedance (no magnetic field). The control voltages can be equal to or less than 300 V, which can make pulses faster and sharper.

The capability of fast pulsing can make the neutron generator 300 useful for a variety of downhole measurements including fast neutron C/O—ratio of carbon and oxygen, and thermal neutron capture elemental analysis. Because of direct electron-impact ionization, the neutron generator 300 gas pressure can be a “free parameter” that can be used for adjusting the current of the ion beam 210, along with the hot cathode 202 electron beam 212 emission. Thus, in a pulsed operation mode, the ion beam 210 current can be adjusted high, reversely proportional to the duty factor, to maintain a constant average ion beam current as if in a CW—continuous wave mode. The already low gas pressure in the ion source 200, combining with no real plasma formation, makes the pulsed operation much easy in control.

Tables 1 and 2 give an example of a pulsing scheme by assuming a 20% duty factor, in comparison to the CW operation. Switching from CW to a low duty factor operation, one simply adjusts the gas reservoir heating to generate a corresponding higher gas pressure needed for the respective peak ion current on target. The pulsing scheme is realized by fast switching both voltages applied to structures 204/218 and 220 in tandem, as highlighted in Table 2, between ion beam on and off. Flipping the extractor bias voltage to a positive value for the off state is found to be very effective to cut-off ion beam tails, i.e., neutron pulse tails, after the pulse is switched off.

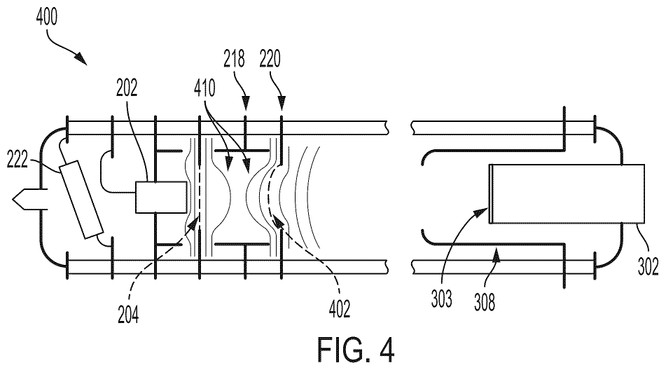

FIG. 4 is a schematic of a neutron generator 400 with a concave-shaped grid 402 on the extractor 220 according to one example of the present disclosure. The ion source can be a triode structure with three applied voltages to 204, 218, and 220. Based on the equal potential lines 410, which are drawn to guide eyes, the E-field inside the region of the ion source cylinder 218 can become more uniform, close to a dipole form, and the ion source 200 can have fewer dead zones for ion extraction. The voltage applied on the ion source cylinder 218 can be tuned for efficient ionization with highest ionization cross sections. The first grid 204 can be used freely for controlling the hot cathode 202, while at the same time, can act in tandem with the extractor 220 containing the second, concave-shaped grid 402 for forming an ion beam.

The first grid 204 for hot cathode 202 control can be beneficial. The electron emission current can be increased by adjusting the voltage of the first grid 204 higher, provided that sufficient hot cathode 202 heating generates an electron beam from electrons available on the cathode surface. In addition, a higher first grid 204 voltage and a lower ion source cylinder 218 voltage can de-accelerate the electrons inside the ion source cylinder 218 toward the 100 eV energy range with highest ionization cross sections for optimizing the ionization processes. Also, a higher voltage on the first grid 204, in combination with the voltage on the second, concave-shaped grid 402 on the extractor 220, can enhance the push-pull tandem effect on ion extraction. Further, the concave-shaped grid 402 on the extractor 220, combined with the suppressor 308, allows for ions to be directed to a center of the target film 303 on the target rod 302, generating a beam spot size on the target that is smaller in radius than the target rod within a central axis of the neutron generator 400.

The triode ion source structure can be further tailored by changing the extractor shape, from a concave, to a flat, or to a convex-shaped grid. The extractor 220 with different-shaped grids can be used to control optics of the ion beam in an acceleration column in advance, which can impact an acceleration distance to the target and the beam spot size on the target.

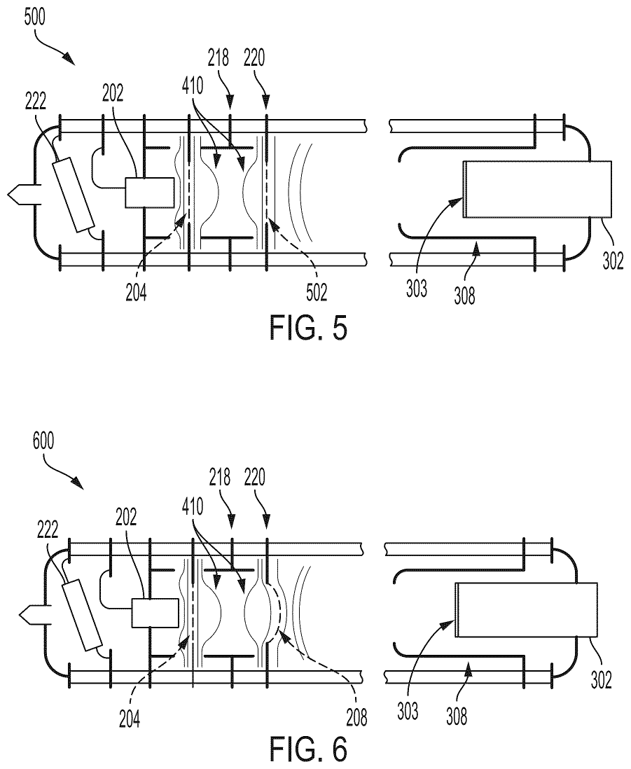

FIG. 5 is a schematic of a neutron generator 500 with a flat-shaped grid 502 on an extractor 220 according to one example of the present disclosure. The neutron generator 500 of FIG. 5 maintains the same features from the previously described structures, while allowing for control of both the electrons inside the region of the ion source cylinder 218 and the ions downstream the extractor 220 with a flat-shaped grid 502 in an acceleration column. The flat-shaped grid 502 on the extractor 220 allows for ions to be directed to a center of the target film 303 on the target rod 302, generating a beam spot size that is larger than the beam spot size generated by the concave-shaped grid 402 and that is in line with a central axis of the neutron generator 500. Altering the shape of a grid may alter the optics of the ion beam, which may alter acceleration of the ion beam and the beam spot size generated by the ion beam.

FIG. 6 is a schematic of a neutron generator 600 with a convex-shaped grid 208 on an extractor according to one example of the present disclosure. The neutron generator 600 of FIG. 6 maintains the same features from the previously described structures, while allowing for control of both the electrons inside the region of the ion source cylinder 218 and the ions downstream the extractor 220 with a convex-shaped grid 208 in an acceleration column. The convex-shaped grid 208 on the extractor 220 allows for ions to be directed to a center of the target film 303 on the target rod 302, generating a beam spot size that is larger than a beam spot size generated by the flat-shaped grid 502 and that is in line with a central axis of the neutron generator 600. Altering the shape of the grid may alter the optics of the ion beam, which may alter acceleration of the ion beam and the beam spot size generated by the ion beam.

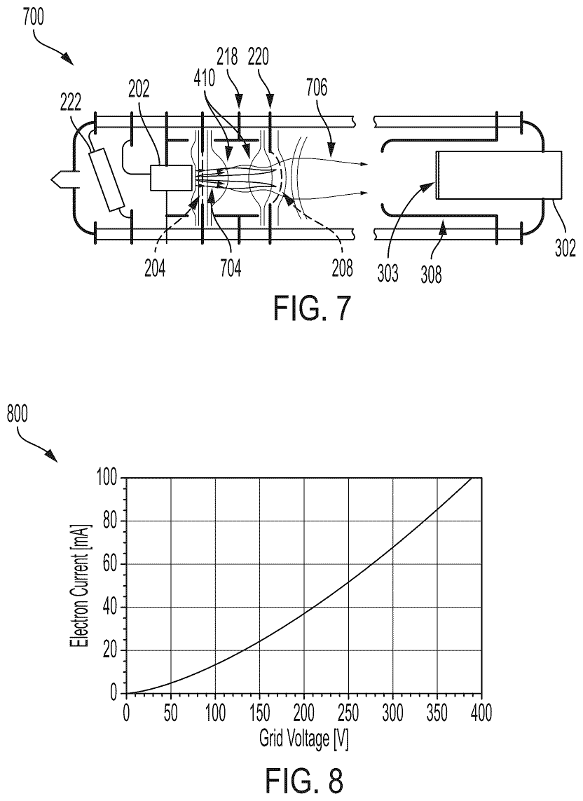

FIG. 7 is a schematic of a neutron generator 700 with a convex-shaped grid 208 for generating ions directed at the target film 303 on a target rod 302 according to one example of the present disclosure. FIG. 7 shows the first grid 204 and the ion source cylinder 218 as separated electrodes, and the extractor 220 with a convex-shaped grid 208, or with a grid that further varies in shape. The electrons 704 can re-circulate inside the region of the ion source cylinder 218 after introducing either a flat-shaped, concave-shaped, or a convex-shaped grid on the extractor 220. The first grid 204 may not be completely transparent and will cause some electron losses. Furthermore, some electrons may be lost to the ion source cylinder 218 walls due to space charge or collisions. But, there still may be a higher ionization efficiency due to contributions from these re-circulating electrons 704. The electron emission current in this case is a sum of currents from the first grid 204 voltage and the ion source cylinder 218 voltage power supplies, which is used for the electron emission control from the hot cathode 202.

With a convex-shaped extractor, an ion beam 706 can be initially defocused. With a strong focusing force from the HV on the suppressor 308, the ion beam 706 can be directed to the target film 303 on the target rod 302. In this way, the geometry can be in a configuration to have a shorter target distance, making the neutron generator 700 more compact in geometry for logging tool applications. And, the geometry can be more favorable to give a larger beam spot size on target, resulting in a slower sputtering rate and longer tube lifetime.

FIG. 8 is a graph of electron emission current as a function of grid voltage for a hot cathode of a neutron generator according to one example of the present disclosure. The chart shows electron emission current (Iₑ) as a function of the voltage of the first grid 204 voltage (voltage of the first grid 204 minus the voltage of the hot cathode 202) for a hot cathode 202 with a radius of 2 mm and positioned at 1.5 mm next to the first grid 204, according to one example of the disclosure. With such a geometry, and the suitable hot cathode 202, an electron current of 40-50 mA can be achieved when applying a voltage to the first grid 204 in a range of 200-250 V. Such a hot cathode can involve a few watts of heating power, and it can provide an operational lifetime beyond 10,000 hours. According to the voltage dependence of the Child Law, the higher the grid voltage is, the higher the electron emission current provided that sufficient space charge is available on the cathode surface due to heating. Therefore, with a separated grid, this can be optimized in the ion source by adjusting the voltage of the first grid higher, close to 250 V.

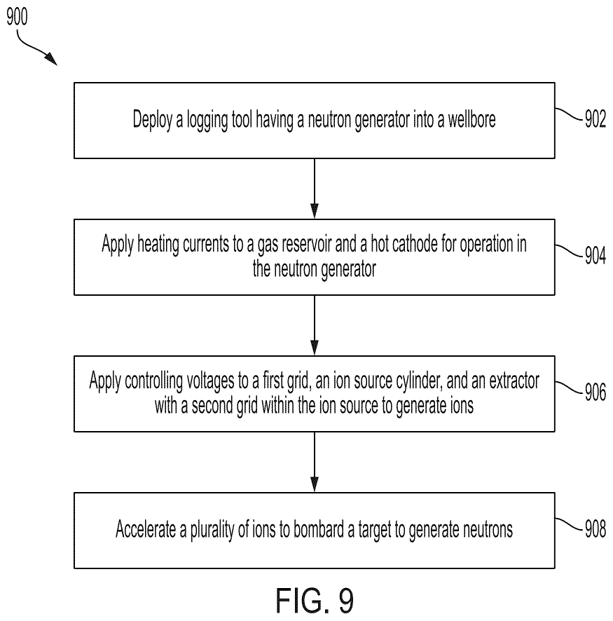

FIG. 9 is a flowchart of a process for using a neutron generator for generating neutrons downhole in a wellbore according to one example of the present disclosure. At block 902, a logging tool having a neutron generator is deployed into a wellbore. The logging tool may be the downhole tool 118 in FIG. 1. The neutron generator 300 can include a housing 206, a gas reservoir 222 positioned within the housing 206, and an ion source 200 positioned within the housing and having a longitudinal axis aligned with a central axis of the housing. The neutron generator may also include a target which is a combination of a suppressor 308, a target film 303 and a target rod 302 positioned within the housing and having a longitudinal axis aligned with the central axis of the housing. The target of the neutron generator 300 is positioned facing an ion source 200 where the ion source 200 is positioned between the gas reservoir 222 and the target. The ion source 200 of the neutron generator 300 may have a triode structure that allows for separate voltages to be applied. The first structure of the triode may be a first grid 204 separated from an ion source cylinder 218. The second structure may be the ion source cylinder 218 within the housing of the neutron generator 300. The third structure of the triode may be an extractor 220 containing a second grid 208.

At block 904, heating currents are applied to a gas reservoir and a hot cathode for operation in the neutron generator. The gas reservoir 222 of the neutron generator 300 can be heated to generate a ionizable gas with a gas pressure of 1.0 mTorr or higher. The hot cathode 202 can be heated to emit electrons near a surface of the hot cathode 202. Applying heating currents to the gas reservoir 222 and the hot cathode 202 may generate an ionizable gas and electrons for forming an electron beam 212 directed to the region of the ion source cylinder 218. The electron beam may be accelerated to ionize an ionizable gas to generate ions.

At block 906 controlling voltages are applied to a first grid, an ion source cylinder, and an extractor with a second grid within the ion source to generate ions. Different and separate voltages are applied to each of the triode structures. The first triode structure may be a first grid 204 which may be physically separated such that no portion of the first grid is in contact with any portion of the ion source cylinder 218. To the first grid 204, a voltage may be applied to produce an electron beam 212 directed to the region of the ion source cylinder 218 to ionize an ionizable gas to generate ions. A voltage may also be applied to the ion source cylinder 218, which is physically separated from the first grid 204. The third controlling voltage may be applied to the extractor 220 with the second grid. Ions, in the form of an ion beam 210, may then be generated and directed to a target.

At block 908, a plurality of ions generated from the ion source 200 are accelerated to bombard a target to generate neutrons. The ions, in the form of an ion beam 210 are accelerated over a distance 310 toward a target film 303 on a target rod 302. A bombardment of ions at the target film 303 may generate neutrons. The target film 303 and the target rod 302 may experience thermal heating of 10 W power caused by the ion beam bombardment with a current of 100 μA at a voltage of 100 kV.

In some aspects, a neutron generator, a logging tool, and a method for neutron logging downhole are provided according to one or more of the following examples: As used below, any reference to a series of examples is to be understood as a reference to each of those examples disjunctively (e.g., “Examples 1-4” is to be understood as “Examples 1, 2, 3, or 4”).

Example 1 is a neutron generator comprising: an ion source within a housing for generating neutrons for neutron logging downhole in a wellbore, the ion source comprising: a hot cathode; an ion source cylinder; a first grid separated from the ion source cylinder; and an extractor separated from the ion source cylinder, the extractor having a second grid.

Example 2 is the neutron generator of example(s) 1, wherein the second grid is a flat-shaped grid, a concave-shaped grid, or a convex-shaped grid.

Example 3 is the neutron generator of example(s) 2, wherein the second grid is the flat-shaped or convex-shaped grid that is configured to have a voltage level that is different than the voltage levels of the ion source cylinder and of the first grid to cause an electron beam to recirculate within the ion source, and to generate an ion beam.

Example 4 is the neutron generator of example(s) 1, further comprising: a gas reservoir for containing and providing an ionizable gas to the hot cathode that is configured to, with the first grid, generate an electron beam directed to the ionizable gas in the ion source, wherein the ion source cylinder is configured to cause electrons to ionize the ionizable gas to generate ions, wherein the extractor with the second grid is configured to generate an ion beam from the ion source; a target rod and a suppressor positionable within the housing and facing the ion source, configured to, with a voltage range of 50-150 kV, accelerate the ion beam from the ion source and receive the ion beam of the ionizable gas, wherein the suppressor is further configured to encapsulate at least a portion of the target rod to suppress secondary electron emission, to trap backscattered ions, and to shield particles sputtered from a target film by ion beam bombardment; and a target film, absorbed with the ionizable gas, positionable on a surface of the target rod and configured to, by ion beam bombardment, generate neutrons within the wellbore.

Example 5 is the neutron generator of example(s) 4, wherein the hot cathode configured to generate the electron beam is configured to generate an electron beam current that correlates with a voltage applied to the first grid.

Example 6 is the neutron generator of example(s) 1, wherein the first grid is physically separated from the ion source cylinder such that no portion of the first grid is in contact with any portion of the ion source cylinder, the first grid being configured to have a voltage level that is different and higher than the voltage level of the ion source cylinder for generating an electron beam.

Example 7 is the neutron generator of example(s) 6, wherein the ion source cylinder is configured to deaccelerate the electron beam within the ion source to ionize an ionizable gas to generate ions.

Example 8 is a logging tool applicable downhole in a wellbore, the logging tool comprising: a sensor device; and a neutron generator for generating neutrons for neutron logging, the neutron generator comprising an ion source that includes: a hot cathode; an ion source cylinder; a first grid separated from the ion source cylinder; and an extractor separated from the ion source cylinder, the extractor having a second grid.

Example 9 is the logging tool of example(s) 8, wherein the second grid is a flat-shaped grid, a concave-shaped grid, or a convex-shaped grid.

Example 10 is the logging tool of example(s) 9, wherein the second grid is the flat-shaped or convex-shaped grid that is configured to have a voltage level that is different than the voltage levels of the ion source cylinder and of the first grid to cause an electron beam to recirculate within the ion source, and to generate an ion beam.

Example 11 is the logging tool of example(s) 8, wherein the neutron generator further comprises: a gas reservoir for containing and providing an ionizable gas to the hot cathode that is configured to, with the first grid, generate an electron beam directed to the ionizable gas in the ion source cylinder, wherein the ion source cylinder is configured to cause electrons to ionize the ionizable gas to generate ions, wherein the extractor with the second grid is configured to generate an ion beam from the ion source; a target rod and a suppressor positionable within a housing and facing the ion source, configured to, with a voltage range of 50-150 kV, accelerate the ion beam from the ion source and receive the ion beam of the ionizable gas, wherein the suppressor is further configured to encapsulate at least a portion of the target rod to suppress secondary electron emission, to trap backscattered ions, and to shield particles sputtered from a target film by ion beam bombardment; and a target film, absorbed with the ionizable gas, positionable on a surface of the target rod and configured to generate neutrons within the wellbore.

Example 12 is the logging tool of example(s) 10, wherein the hot cathode configured to generate the electron beam is configured to generate an electron beam current that correlates with a voltage applied to the first grid.

Example 13 is the logging tool of example(s) 8, wherein the first grid is physically separated from the ion source cylinder such that no portion of the first grid is in contact with any portion of the ion source cylinder, the first grid being configured to have a voltage level that is different and higher than the voltage level of the ion source cylinder for generating an electron beam.

Example 14 is the logging tool of example(s) 13, wherein the ion source is configured to deaccelerate the electron beam within the ion source to ionize an ionizable gas to generate ions.

Example 15 is a method comprising: deploying a logging tool having a neutron generator into a wellbore, the neutron generator comprising an ion source that includes: a hot cathode; an ion source cylinder; a first grid separated from the ion source cylinder; and an extractor separated from the ion source cylinder, the extractor having a second grid; ionizing an ionizable gas within the ion source with the ion source cylinder separated from the first grid to create a plurality of ions; and accelerating the plurality of ions toward a target and generating a plurality of neutrons; transmitting the plurality of neutrons from the neutron generator into a formation surrounding the wellbore; and receiving a signal measurement related to the plurality of neutrons at one or more sensors in the logging tool.

Example 16 is the method of example(s) 15, wherein the second grid is a flat-shaped grid, a concave-shaped grid, or a convex-shaped grid.

Example 17 is the method of example(s) 16 further comprising: re-circulating an electron beam within the ion source; and generating an ion beam from the ion source, by the extractor with the flat-shaped or convex-shaped, second grid having a voltage level that is different than the voltage levels of the ion source cylinder and of the first grid.

Example 18 is the method of example(s) 15 further comprising: containing and providing, by a gas reservoir, an ionizable gas to the hot cathode for, with the first grid, generating an electron beam directed to the ionizable gas in the ion source, wherein the ion source, with the first grid, the ion source cylinder, and second grid on the extractor, generates ions from an ionizable gas, wherein the extractor with the second grid generates an ion beam from the ion source; positioning a target rod and a suppressor within a housing having a voltage range of 50-150 kV and facing the ion source, for accelerating the ion beam from the ion source and receiving the ion beam of the ionizable gas, wherein the suppressor encapsulates at least a portion of the target rod to suppress secondary electron emission, to trap backscattered ions, and to shield particles sputtered from a target film by ion beam bombardment; and positioning a target film, absorbed with the ionizable gas, on a surface of the target rod and for generating neutrons within the wellbore.

Example 19 is the method of example(s) 15, wherein the first grid is physically separated from the ion source cylinder such that no portion of the first grid is in contact with any portion of the ion source cylinder, the first grid having a voltage level that is different and higher than the voltage level of the ion source cylinder for generating an electron beam.

Example 20 is the method of example(s) 19, wherein the ion source cylinder deaccelerates the electron beam within the ion source to ionize an ionizable gas to generate ions.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A neutron generator comprising:
an ion source within a housing for generating neutrons for neutron logging downhole in a wellbore, the ion source comprising:
a hot cathode;
an ion source cylinder;
a first grid separated from the ion source cylinder; and
an extractor separated from the ion source cylinder, the extractor having a second grid.

2. The neutron generator of claim 1, wherein the second grid is a flat-shaped grid, a concave-shaped grid, or a convex-shaped grid.

3. The neutron generator of claim 2, wherein the second grid is the flat-shaped or convex-shaped grid that is configured to have a voltage level that is different than the voltage levels of the ion source cylinder and of the first grid to cause an electron beam to recirculate within the ion source, and to generate an ion beam.

4. The neutron generator of claim 1, further comprising:
a gas reservoir for containing and providing an ionizable gas to the hot cathode that is configured to, with the first grid, generate an electron beam directed to the ionizable gas in the ion source,
wherein the ion source cylinder is configured to cause electrons to ionize the ionizable gas to generate ions,
wherein the extractor with the second grid is configured to generate an ion beam from the ion source;
a target rod and a suppressor positionable within the housing and facing the ion source, configured to, with a voltage range of 50-150 kV, accelerate the ion beam from the ion source and receive the ion beam of the ionizable gas,
wherein the suppressor is further configured to encapsulate at least a portion of the target rod to suppress secondary electron emission, to trap backscattered ions, and to shield particles sputtered from a target film by ion beam bombardment; and
a target film, absorbed with the ionizable gas, positionable on a surface of the target rod and configured to, by ion beam bombardment, generate neutrons within the wellbore.

5. The neutron generator of claim 4, wherein the hot cathode configured to generate the electron beam is configured to generate an electron beam current that correlates with a voltage applied to the first grid.

6. The neutron generator of claim 1, wherein the first grid is physically separated from the ion source cylinder such that no portion of the first grid is in contact with any portion of the ion source cylinder, the first grid being configured to have a voltage level that is different and higher than the voltage level of the ion source cylinder for generating an electron beam.

7. The neutron generator of claim 6, wherein the ion source cylinder is configured to deaccelerate the electron beam within the ion source to ionize an ionizable gas to generate ions.

8. A logging tool applicable downhole in a wellbore, the logging tool comprising:
a sensor device; and
a neutron generator for generating neutrons for neutron logging, the neutron generator comprising an ion source that includes:
a hot cathode;
an ion source cylinder;
a first grid separated from the ion source cylinder; and
an extractor separated from the ion source cylinder, the extractor having a second grid.

9. The logging tool of claim 8, wherein the second grid is a flat-shaped grid, a concave-shaped grid, or a convex-shaped grid.

10. The logging tool of claim 9, wherein the second grid is the flat-shaped or convex-shaped grid that is configured to have a voltage level that is different than the voltage levels of the ion source cylinder and of the first grid to cause an electron beam to recirculate within the ion source, and to generate an ion beam.

11. The logging tool of claim 8, wherein the neutron generator further comprises:
a gas reservoir for containing and providing an ionizable gas to the hot cathode that is configured to, with the first grid, generate an electron beam directed to the ionizable gas in the ion source cylinder,
wherein the ion source cylinder is configured to cause electrons to ionize the ionizable gas to generate ions,
wherein the extractor with the second grid is configured to generate an ion beam from the ion source;
a target rod and a suppressor positionable within a housing and facing the ion source, configured to, with a voltage range of 50-150 kV, accelerate the ion beam from the ion source and receive the ion beam of the ionizable gas,
wherein the suppressor is further configured to encapsulate at least a portion of the target rod to suppress secondary electron emission, to trap backscattered ions, and to shield particles sputtered from a target film by ion beam bombardment; and
a target film, absorbed with the ionizable gas, positionable on a surface of the target rod and configured to generate neutrons within the wellbore.

12. The logging tool of claim 10, wherein the hot cathode configured to generate the electron beam is configured to generate an electron beam current that correlates with a voltage applied to the first grid.

13. The logging tool of claim 8, wherein the first grid is physically separated from the ion source cylinder such that no portion of the first grid is in contact with any portion of the ion source cylinder, the first grid being configured to have a voltage level that is different and higher than the voltage level of the ion source cylinder for generating an electron beam.

14. The logging tool of claim 13, wherein the ion source is configured to deaccelerate the electron beam within the ion source to ionize an ionizable gas to generate ions.

15. A method comprising:
deploying a logging tool having a neutron generator into a wellbore, the neutron generator comprising an ion source that includes:
a hot cathode;
an ion source cylinder;
a first grid separated from the ion source cylinder; and
an extractor separated from the ion source cylinder, the extractor having a second grid;
ionizing an ionizable gas within the ion source with the ion source cylinder separated from the first grid to create a plurality of ions; and
accelerating the plurality of ions toward a target and generating a plurality of neutrons;
transmitting the plurality of neutrons from the neutron generator into a formation surrounding the wellbore; and
receiving a signal measurement related to the plurality of neutrons at one or more sensors in the logging tool.

16. The method of claim 15, wherein the second grid is a flat-shaped grid, a concave-shaped grid, or a convex-shaped grid.

17. The method of claim 16 further comprising:
re-circulating an electron beam within the ion source; and
generating an ion beam from the ion source, by the extractor with the flat-shaped or convex-shaped, second grid having a voltage level that is different than the voltage levels of the ion source cylinder and of the first grid.

18. The method of claim 15 further comprising:
containing and providing, by a gas reservoir, an ionizable gas to the hot cathode for, with the first grid, generating an electron beam directed to the ionizable gas in the ion source,
wherein the ion source, with the first grid, the ion source cylinder, and second grid on the extractor, generates ions from an ionizable gas,
wherein the extractor with the second grid generates an ion beam from the ion source;
positioning a target rod and a suppressor within a housing having a voltage range of 50-150 kV and facing the ion source, for accelerating the ion beam from the ion source and receiving the ion beam of the ionizable gas,
wherein the suppressor encapsulates at least a portion of the target rod to suppress secondary electron emission, to trap backscattered ions, and to shield particles sputtered from a target film by ion beam bombardment; and
positioning a target film, absorbed with the ionizable gas, on a surface of the target rod and for generating neutrons within the wellbore.

19. The method of claim 15, wherein the first grid is physically separated from the ion source cylinder such that no portion of the first grid is in contact with any portion of the ion source cylinder, the first grid having a voltage level that is different and higher than the voltage level of the ion source cylinder for generating an electron beam.

20. The method of claim 19, wherein the ion source cylinder deaccelerates the electron beam within the ion source to ionize an ionizable gas to generate ions.
